(19) United States
(12) Patent Application Publication
(10) Pub. No.: US 2015/0242038 A1
(43) Pub. Date: Aug. 27, 2015

(54) FILTER MODULE TO DIRECT AUDIO FEEDBACK TO A PLURALITY OF TOUCH MONITORS

(71) Applicant: TOSHIBA GLOBAL COMMERCE SOLUTIONS HOLDINGS CORPORATION, Tokyo (JP)

(72) Inventors: David John STEINER, Raleigh, NC (US); John David LANDERS, Jr., Raleigh, NC (US); Charles Ray KIRK, Raleigh, NC (US)

(73) Assignee: TOSHIBA GLOBAL COMMERCE SOLUTIONS HOLDINGS CORPORATION, Tokyo (JP)

(21) Appl. No.: 14/187,496

(22) Filed: Feb. 24, 2014

(51) Int. Cl. G06F 3/041; H04R 3/00

(52) U.S. Cl. CPC G06F 3/0416; G06F 3/0412; H04R 3/00

(57) ABSTRACT

Multiple users may interact with the multiple touch monitors simultaneously. For example, a point-of-sale (POS) system may include two touch monitors (e.g., one facing the cashier and another facing the customer) that are controlled by the same operating system. To provide audio feedback to both users, the operating system needs to know on which monitor the touch event occurred. However, because the operating system may use a shared coordinate region, it only knows that a touch event occurred within the region but not know on which monitor. As such, embodiments herein describe a filter module that identifies a specific location of a touch event within the shared coordinate region and maps that location to one of the touch monitors. Once the specific touch monitor is identified, the filter module sends an instruction that causes a speaker assigned to the identified touch monitor to output the audio feedback.

### BACKGROUND

The present invention relates to audio feedback for touch events on multiple touch-sensitive displays, and more specifically, to using a filter module in a processing system for selecting a speaker to output the audio feedback.

Touch screens are increasingly being used to supplement or replace more traditional input/output (I/O) devices such as a mouse or keyboard. These traditional I/O devices include different mechanisms for informing the user when a switch is activated. For example, pressing a button on a keyboard provides physical feedback in the form of pressure that indicates to the user that a button was successfully pressed. Also, the buttons on many keyboards inherently produce a sound when pressed that informs the user that a button was activated. Similarly, a mouse button typically emits an audible click when activated by a user. These feedback mechanisms enable a user to quickly determine when a button was activated.

Touch screens, however, do not have physical mechanisms such as buttons or switches that provide audio or physical feedback for informing the user when the screen has detected user input. For example, capacitive sensing screens detect the presence of an input object (e.g., a human finger or stylus) proximate to the screen by detecting a change in an electrical field. The touch screen includes a touch controller that monitors different electrodes in the screen to determine when a touch event has occurred. To inform the user that a touch event was detected, the touch screen may provide visual feedback to the user. For example, the touch screen may illustrate a graphic of a virtual button being pressed. However, visual feedback requires that a user be constantly viewing the touch screen while audio feedback, such as is provided by a keyboard or mouse, provide feedback without requiring the user to look at the screen.

### SUMMARY

Embodiments of the present disclosure include a method and a computer program product for providing audio feedback for a first touch-sensitive display and a second touch-sensitive display. The method and computer program product include receiving touch data from one of the first and second displays where the touch data indicating that a touch event occurred on one of a first integrated touch/display area in the first display and a second integrated touch/display area of the second display. Furthermore, the first and second displays are housed in separate physical enclosures. The method and computer program product also include identifying a location of the touch event in a shared coordinate region that extends across both the first touch/display area and the second touch/display area and selecting one of the first and second displays by correlating the location of the touch event to a sub-portion of the shared coordinate region corresponding to one of the first and second touch/display areas. The method and computer program product include transmitting a signal to a speaker assigned to the selected display, the signal causing the speaker to output audio feedback associated with the touch event.

Another embodiment described herein is a system that includes a computer processor and a memory containing a program that, when executed on the computer processor, performs an operation for processing data. The operation includes receiving touch data from one of the first and second displays, the touch data indicating that a touch event occurred on one of a first integrated touch/display area in the first display and a second integrated touch/display area of the second display. The operation also includes identifying a location of the touch event in a shared coordinate region that extends across both the first touch/display area and the second touch/display area and selecting one of the first and second displays by correlating the location of the touch event to a sub-portion of the shared coordinate region corresponding to one of the first and second touch/display areas. The operation includes transmitting a signal to a speaker assigned to the selected display, the signal causing the speaker to output audio feedback associated with the touch event.

### BRIEF DESCRIPTION OF THE SEVERAL VIEWS OF THE DRAWINGS

FIG. 1 illustrates two touch monitors that form a shared coordinate region, according to one embodiment described herein.

FIG. 2 illustrates a computing system with a filter module for selecting which speaker to provide audio feedback for a touch event, according to one embodiment described herein.

FIG. 3 illustrates a method for selecting a speaker to provide audio feedback based on a location of a touch event, according to one embodiment described herein.

FIG. 4 illustrates a computer system with speakers arranged to provide directional audio feedback, according to one embodiment described herein.

FIG. 5 illustrates a computer system with a single speaker that provides audio feedback for a plurality of touch monitors, according to one embodiment described herein.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

Many touch controllers do not provide an interface that includes an output for providing audio feedback corresponding to touch events. For example, a touch controller embodied in an integrated circuit may not include an output pin that provides a signal that can be used to provide audio feedback. Nonetheless, a user may prefer receiving audio feedback in addition to, or in lieu of, visual feedback when the touch controller detects a touch event. To provide the audio feedback, a driver may be added to the operating system stack that provides audio feedback to the user when touch events are detected.

Some computer systems include multiple touch-sensitive displays that are controlled by the same operating system. As used herein, a touch-sensitive display is a physical structure that includes a display screen and a touch sensitive region. In one embodiment, the touch sensitive region is integrated into the display screen. For example, the operating system may display an image on the display screen which the user can interact with using the touch sensitive region. Although the embodiments that follow specifically recite using a touch monitor, the techniques described herein may be applied to any touch-sensitive display. In one embodiment, if a system includes multiple touch monitors, the operating system may use the same coordinate region to identify locations on the touch monitors. In one example, the operating system extends its desktop across both monitors such that the monitors display different sub-portions of the desktop—e.g., a shared coordinate region.

Multiple users may interact with the multiple touch monitors simultaneously. For example, a point-of-sale (POS) system may include two touch monitors (e.g., one facing the cashier and another facing the customer) that are controlled by the same operating system. To provide audio feedback to both the customer and the cashier when interacting with the touch monitors, the operating system needs to know on which monitor the touch event occurred. However, because the operating system uses a shared coordinate region, it only knows that a touch event occurred within the region but does not know on which monitor the event occurred. As such, embodiments herein describe a filter module executing in the operating system stack that identifies a specific location of a touch event within the shared coordinate region and maps that location to one of the touch monitors. Once the specific touch monitor that received the touch event is identified, the filter module sends a signal (e.g., a data instruction) that causes a speaker assigned to the identified touch monitor to output the audio feedback. For example, each touch monitor may be assigned to a specific speaker. By controlling which speaker outputs the audio feedback, the filter module provides the audio feedback to the appropriate user (e.g., the customer or the cashier).

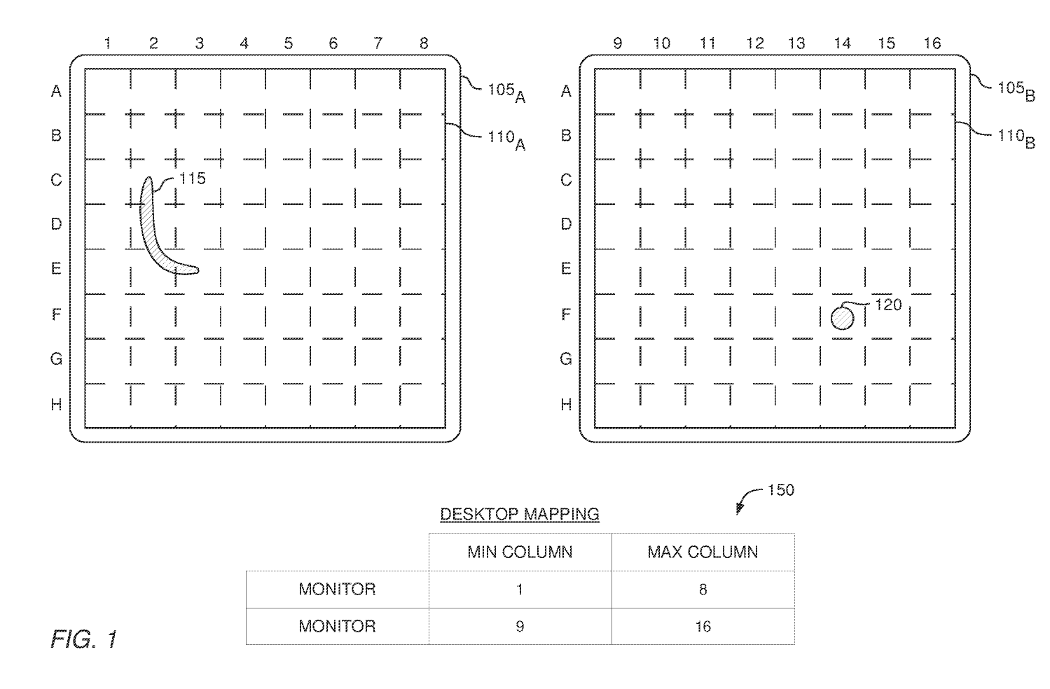

FIG. 1 illustrates two touch monitors 105 that form a shared coordinate region, according to one embodiment described herein. In one embodiment, each touch monitor 105 displays a non-overlapping sub-portion of the same coordinate region. As such, even though two monitors 105 are used, the operating system treats the display areas of each monitor 105 as one large coordinate region—e.g., one desktop.

As shown, each monitor 105 includes a display screen 110 that defines a display area where images transmitted by the operating system are displayed to the user. It is assumed that the display screen 110 also defines a touch sensitive region that is the same size as the display area, but this is not a requirement as the touch sensitive region in the display screen 110 may be smaller than the display area. In one embodiment, the monitors 105 include respective touch controllers that monitor different electrodes in the screens 110 to determine when a touch event has occurred within the touch sensitive region. For example, the touch controllers may use capacitive sensing for detecting user interaction with the touch screens 110 by monitoring a change in an electric field generated by the electrodes. However, in other embodiments, the touch monitors 105 may use a different form of touch sensing such as inductive or resistive sensing. Moreover, although the term “touch event” is used to describe when a touch controller detects user interaction with the touch monitor 105, a touch event may also be generated when the user does not actually touch or make physical contact with the monitor 105. For instance, the user may hover a finger near the touch sensitive region and still generate a touch event.

FIG. 1 illustrates two touch events that may occur simultaneously or in parallel. For example, a first user may swipe an input object (e.g., a human digit or stylus) across the display area 110A of monitor 105A to generate touch event 115 while, in parallel, a second user taps the display area 110B of monitor 105B to generate touch event 120. In response, the respective touch controllers generate touch data describing the touch events 115, 120 which is then transmitted to the operating system. The operating system may convert the touch data into one or more user commands that instruct the operating system to, for example, navigate through windows displayed on the touch monitor, purchase an item, search the Internet, query a database, and the like.

Because the operating system considers the respective display areas 110 as portions of the same coordinate region, it simply knows that two touch events were detected within the coordinate region but does not know if the touch events 115, 120 occurred on the same touch monitor 105 or on different touch monitors 105. Accordingly, if the operating system wants to provide audio feedback, it does not differentiate between touch events that occurred on one monitor 105 versus touch events that occurred on another monitor 105. This may be acceptable if only one user is operating both touch monitors 105 (i.e., one user initiates both touch events 115 and 120), but if two users are operating the touch monitors 105 they may be confused whether the audio feedback provided by the operating system is intended for them or for the other user. But without first identifying on which touch monitor 105 the touch event occurred, the operating system is unable to provide audio feedback to a specific user rather than to both users at once.

As shown here, the shared coordinate region is divided into rows and columns. A first portion of the coordinate region—i.e., Rows A-H and Columns 1-8—map to touch monitor 105A while a second portion of the coordinate region—i.e., Rows A-H, Columns 9-16—map to touch monitor 105B. Logically dividing the coordinate region into rows and columns is just one embodiment of identifying location or sub-regions of a shared coordinate region. In another embodiment, the operating system may use pixel locations to identify a location within the coordinate region. Regardless of the specific methodology used to identify a location, the touch controller may transmit to the operating system the location of the touch events 115 and 120, the duration of the event, a velocity of the user's motion, and the like. In addition to including the location of the touch event, the touch data generated by the touch controller may also indicate, for example, a type of the touch event (e.g., finger swipe, single tap, double tap, multiple finger contact, and the like) or this characterization may be done by the operating system. As shown here, touch event 115 occurred in a sub-region that includes Column 2, Rows C-E and Column 3, Row E while touch event 120 is at Column 14, Row F. Of course, other touch events (such as multi-touch) may include multiple locations within the coordinate regions that are not contiguous. For example, instead of touching the monitor 105A only at location Column 14, Row F, the user may use a second digit to touch, e.g., Column 13, Row D. The touch controller (or the operating system) may characterize these two user interactions as the same touch event or separate touch events.

To provide audio feedback to a specific user, the filter module in the operating system may use the desktop mapping 150 to identify which touch monitor detected the touch event. The mapping 150 may be any type of data structure that identifies what portion of the shared coordinate region is assigned to the touch monitors 105. In this example, Columns 1-8 are assigned to monitor 105A and Column 9-16 are assigned to monitor 105B. Using this mapping 150 and the location data provided by the touch controller, the filter module determines which touch monitor 105 detected the touch event. For instance, because touch event 115 occurred within Columns 1-8, the filter module knows touch event 115 occurred on monitor 105A. As will be discussed in greater detail below, the filter module may then transmit the audio feedback to a speaker assigned to monitor 110A.

Although FIG. 1 shows only two touch monitors 105, any number of touch monitors can be used (up to the maximum permitted by the operating system). As new touch monitors are added, the operating system simply extends the shared coordinate region to include the new monitors. For example, a third monitor may be added and assigned to Row A-H and Columns 17-24 or assigned to Rows I-P and Columns 1-8. The portion of the shared coordinate region assigned to the third touch monitor is then added to the desktop mapping 150 so the filter module can assign received touch events to a particular touch monitor.

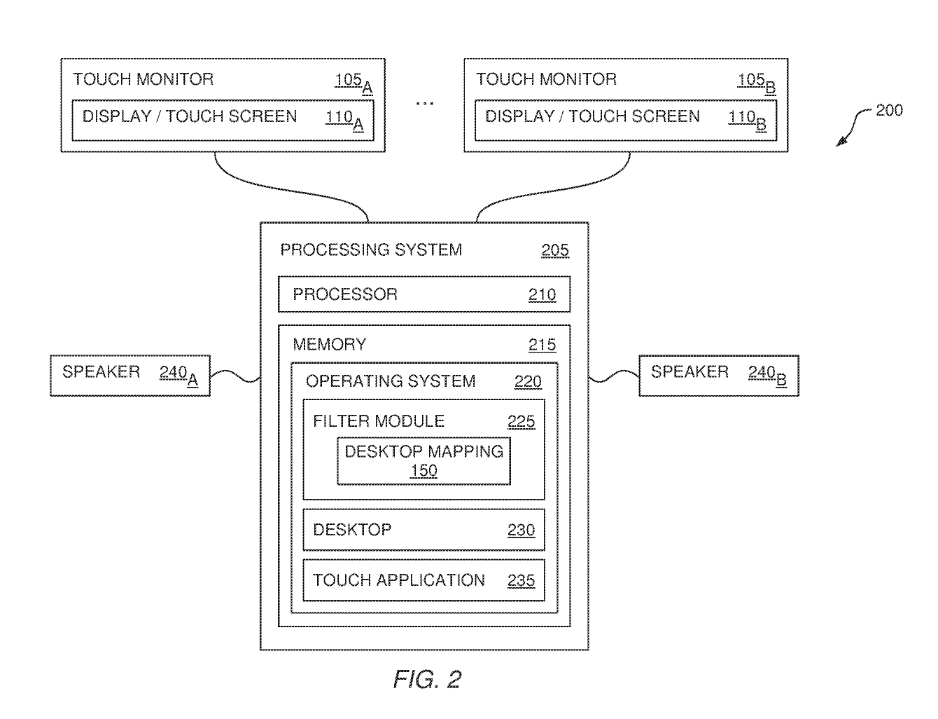

FIG. 2 illustrates a computing system 200 with the filter module for selecting which speaker to provide audio feedback for a touch event, according to one embodiment described herein. The computing system 200 includes two touch monitors 105, processing system 205, and two speakers 240. As discussed above, the touch monitors 105 include integrated touch and display screens 110 that permit a user to interact with an image displayed on the monitor. The touch monitors 105 may be housed in separate physical enclosures or housed in the same enclosure. As an example of the latter, monitor 105A may be on one side of enclosure (e.g., facing a customer) while monitor 105B is one another side of the enclosure (e.g., facing a cashier).

Both touch monitors 105 are coupled to the processing system 205. In one embodiment, the processing system 205 may be contained within a physical enclosure separate from the touch monitors 105. For example, the touch monitors 105 may be standalone monitors that use cables (e.g., USB or HDMI cables) to communicate with the processing system 205 that is housed in a computer tower. However, in another embodiment, the touch monitors 105 and processing system 205 may be housed in the same physical enclosure to form an integrated computing system 200.

The processing system 205 includes a processor 210 and memory 215. The processor 210 represents any number of individual processors. Furthermore, these processors may contain any number of processing elements (e.g., processing cores). Memory 215 may include volatile memory (e.g., DRAM), non-volatile memory (e.g., Flash or hard disk drives), or combinations thereof. As shown, memory 215 includes an operating system 220 that may be any operating system capable of performing the functions described herein. In one embodiment, the operating system 220 defines a desktop 230 (e.g., a coordinate region) that is displayed on the display/touch screens 110 of the touch monitors 105. As discussed above, the desktop 230 may extend across both monitors 105 such that monitor 105A displays a first portion of the desktop 230 and monitor 105B displays a second portion of the desktop 230. In one embodiment, the first and second portions do not overlap. A non-limiting list of example operating systems 220 that extend a shared coordinate region across multiple monitors include versions of Windows® (Windows is a registered trademark of Microsoft Corporation in the United States and other countries) and versions of Linux® (Linux is a registered trademark of Linus Torvalds in the United States and other countries)

In one embodiment, the desktop 230 is mapped into a collection of unique locations that can be used to arrange icons, windows, applications, or any other display element within the desktop 230. Once the arrangement is set, the operating system 220 and a graphics adapter (not shown) generate respective display frames that the touch monitors 105 use to update the pixels in the screens 110 to display the desired arrangement. The user is then able to interact with the displayed elements using the touch sensitive region of the screen 110. For example, the desktop 230 may currently include a plurality of displayed folders. The user may double tap on the folder she wishes to open. In response, the touch controller sends touch data indicating the location of the user interaction to the operating system 220. Using the touch application 235, the operating system 220 determines the user has double tapped on a location of the desktop 230 that includes a folder icon. That is, the touch application 235 converts the touch data into user commands that are to be carried out by the operating system—e.g., opening the folder. The operating system 220 then updates the desktop 230 so that the contents of the selected folder are displayed and transmits new display frames of the desktop 230 to the touch monitors 105.

Furthermore, the displayed images in both monitors 105 may be different. For example, the operating system 220 may update the desktop 230 such that the portion of the desktop 230 displayed on monitor 105A is a first application but the portion of the desktop 230 displayed on monitor 105B is a second application. If a first user interacts with a display element in the first application at the same time a second user interacts with a display element in the second application, the operating system 220 can update the desktop 230 accordingly and transmit new display frames for each of the monitors 105. Thus, two different users can use the same operating system 220 and the same desktop 230 to present two different displayed images to the user.

The operating system 220 also includes the filter module 225 which is tasked with providing audio feedback for the users (or user) operating the touch monitors 105. A user may want to know whether the touch monitor 105 detected a touch event. Instead of relying solely on a visual prompt, the operating system 220 uses the filter module 225 to output audio feedback for the respective touch monitors 105. To do so, the filter module 225 determines whether a touch event was detected, and if so, which touch monitor detected the event. For example, the filter module 225 may monitor the touch data received from the touch monitors 105. This data may be encoded to inform the touch application 235 when user interaction with the screen 110 has triggered a touch event. The filter module 225 may monitor this data to determine that a touch event has occurred. Alternatively, the filter module 225 may receive a message from the touch application 235 when a touch event is detected. That is, in addition to converting the touch data into user commands, the touch application 235 may inform the filter module 225 that a touch event has occurred.

Upon determining a touch event has occurred, the filter module 225 may use the location of the touch event within the desktop 230 to identify which touch monitor 105 detected the touch event. In one embodiment, the filter module 225 uses the location of the touch event to index into the desktop mapping 150 which indicates what portion of the desktop 230 is assigned to the touch monitors 105. Once the correct monitor 105 is selected, the filter module 225 determines which speaker 240 is assigned to that monitor 105. For instance, the filter module 225 may include a data structure (e.g., a table or array) that indicates which speaker 240 is assigned to which monitor 105. The filter module 225 then sends an instruction that causes the assigned speaker 240 to output the audio feedback corresponding to the touch event. For example, speaker 240A may be assigned provide audio feedback for touch events detected by touch monitor 105A while speaker 240B is assigned to output audio feedback for touch events detected by touch monitor 105B. Thus, if a touch event is detected by monitor 105A, speaker 240A outputs the audio feedback but speaker 240B does not. As will be discussed in more detail below, in one embodiment, the speakers 240 may be arranged such that the users can easily determine that the audio feedback is intended for them and not for another user who is using a different touch monitor 105.

In one embodiment, the speakers 240 may be part of the same audio unit. For example, speaker 240A may be a right channel of the audio unit while speaker 240B is the left channel for the same audio unit. Or, if more than two touch monitors are used, this technique can be expanded to other audio channels such as center, left-rear, right-rear, etc., which can each be assigned to a particular touch monitor. Thus, upon determining which touch monitor 105 detected the touch event, the operating system 220 uses the corresponding audio channel to route the audio feedback to the appropriate speaker 240. Moreover, instead of being coupled to the processing system 205, the speakers 240 may be coupled to the touch monitors 105. For instance, the speakers 240 may be respectively coupled to a USB hub in the monitors 105 or may be integrated into the monitors 105. In these examples, the filter module 225 transmits an instruction to the appropriate touch monitor 105 which outputs the audio feedback using the coupled speaker 240.

The filter module 225 may be software, firmware, hardware, or combinations thereof. If the filter module 225 is software or firmware, then an operating system 220 that does not currently have the ability to output audio feedback based on which touch monitor detected a touch event can be upgraded to include the filter module 225 without have to add new hardware to the processing system 205. For example, the filter module 225 may be a device driver that permits the touch monitors 105 to interface with the processing system 205.

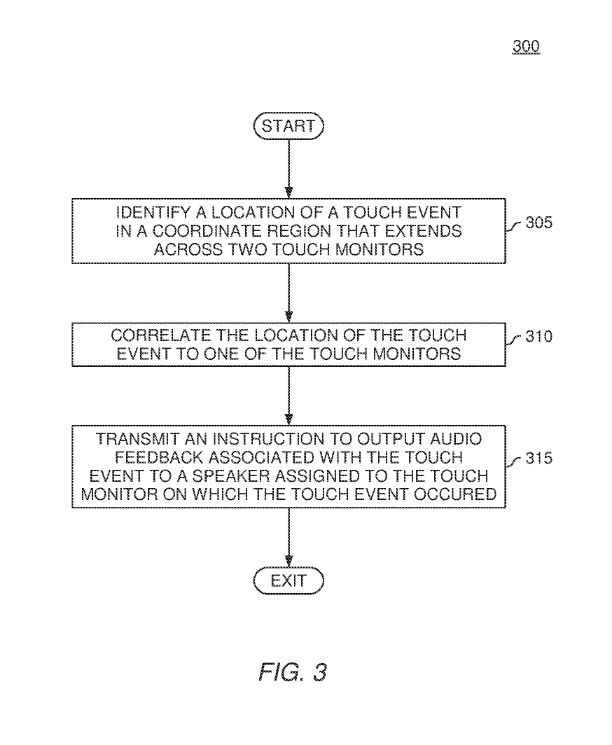

FIG. 3 illustrates a method 300 for selecting a speaker to provide audio feedback based on a location of a touch event, according to one embodiment described herein. In method 300, it is assumed that the touch events may have been sent to the operating system 220 from any one of a plurality of touch monitors. If multiple users are operating the plurality of touch monitors, simply outputting audio feedback for the touch event using on any speaker may confuse the user—i.e., the users will not know who is the intended recipient of the audio feedback. To output the audio feedback in a manner that indicates to the users who the correct recipient is, at block 305, a filter module identifies a location of the received touch event in a coordinate region (e.g., the desktop of the operating system) that extends across the plurality of touch monitors. For example, the touch data transmitted by the touch monitors to the operating system may include the location within the coordinate region where the user interacted with the screen.

At block 310, the filter module correlates the location of the touch event in the coordinate region to one of the plurality of touch monitors. To do so, the filter module may use the desktop mapping data structure discussed above which maps different sub-portions of the coordinate region to each of the touch monitors. By determining in which sub-portion the touch event is located, the filter module can identify the touch monitor that detected the touch event.

At block 315, the filter module transmits an instruction to output audio feedback associated with the touch event to a speaker assigned to the touch monitor identified at block 310. In one embodiment, a network administrator may configure the filter module by populating a data structure that indicates which speaker is assigned to which monitor. For example, the network administrator may arrange the speakers so that, for each of the touch monitors, at least one speaker is directed at a location where a user of the touch monitor is likely to stand or sit. This speaker is then assigned to the corresponding touch monitor in the data structure. When the filter module identifies a specific touch monitor at block 310, it uses this data structure to transmit the audio output to the assigned speaker (or speakers) that is directed at the user of the touch monitor.

The audio output may range from a short beep (e.g., less than half a second) to a spoken word or statement. For example, the audio output may be multiple beeps, music, ringing, verbal output, and the like. In one embodiment, the audio feedback may differ depending on the type of touch event was detected. For example, if the user taps the touch monitor once, the filter module may instruct the speaker to output a single beep, but if the user taps the monitor twice (i.e., double-taps), the filter module instructs the speaker to output two beeps. In this manner, the user is able to hear the audio output and determine what type of input was detected. For example, if the user double-taps but only hears one beep, she can know that the touch controller missed the second tap. Other types of touch events that may be associated with different audio feedback include swipes, multi-contact (touching the screen at multiple locations simultaneously), and the like.

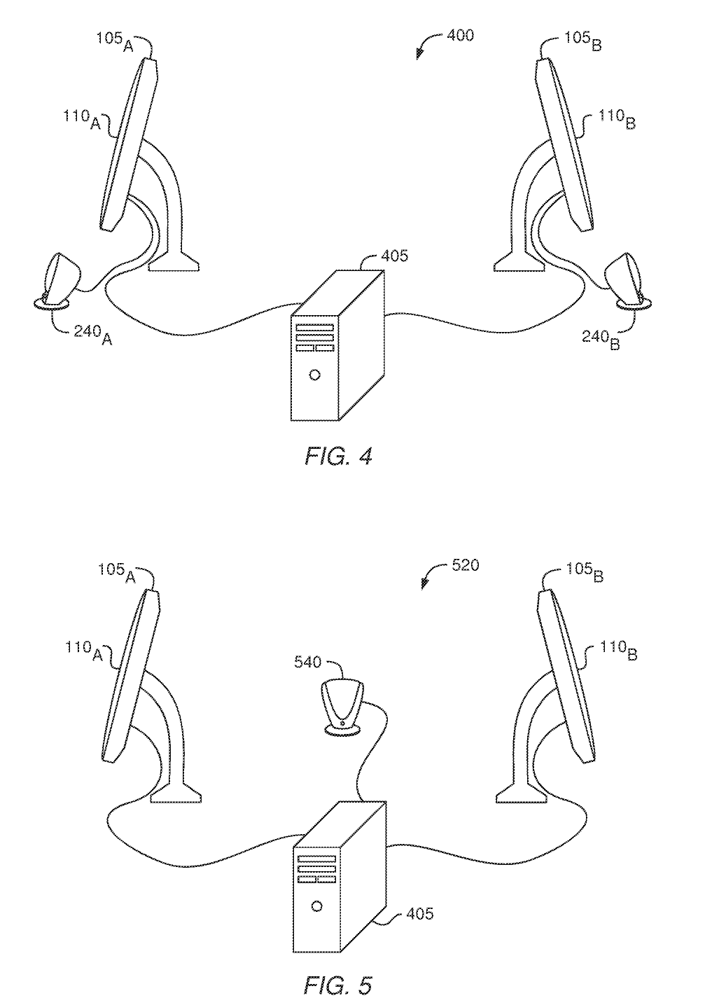

FIG. 4 illustrates a computer system 400 with speakers 240 arranged to provide directional audio feedback, according to one embodiment described herein. As shown, computer system 400 includes two touch monitors 105 with corresponding speakers 240 attached to a physical enclosure 405 that contains a processing system which includes the operating system and filter module described above.

In one embodiment, the computing system 400 may be a POS system where one monitor is used by the store's cashier (e.g. monitor 105A) while the other monitor is used by the customer (e.g., monitor 105B). Because the cashier and the customer may be separated by a counter or scanning area, the monitors 105 are arranged in different directions to be viewable by the respective users. Although FIG. 4 illustrates the touch monitors 105 being arranged back-to-back, any arrangement is possible—e.g., the screens 110 of the touch monitors 105 may be perpendicular to each other. When scanning items the customer wishes to purchase, the cashier may use touch monitor 105A to enter information (e.g., coupon information or an item's identification number), instruct the POS system to perform an auxiliary function (e.g., weigh an item using a built-in scale), inform the POS system of the customer's payment method (e.g., whether the customer is paying with cash, debit, or credit), and the like. To do so, the cashier uses any number of gestures or actions that are interpreted by the touch controller in the monitor 105A as respective touch events. As described above, these touch events are transmitted to the operating system which performs the user commands associated with these touch events. Because the cashier repeatedly provides these instructions to the system 400, she may be able to interact with the screen 110A without looking at the touch monitor 105A. For example, the cashier may know where to touch the screen 110A to instruct the POS system to weigh an item without looking. If the cashier is not looking at the screen and without audio feedback, the cashier is unable to know whether the POS system received the instructions. But because computer system 400 includes directional speaker 240A which may be pointing at the cashier—e.g., pointing in a direction normal to the plane established by the screen 110A—the user can receive audio feedback informing her that the touch event was detected. Stated generally, the speaker 240A may be directed at an area where the user of the monitor 110A is expected to stand or sit. Thus, once a relevant touch event is detected by the operating system, the filter module identifies what monitor 105 detected the touch event and sends an instruction that causes the directional speaker 240 assigned to that monitor 105 to output the desired audio feedback. By providing audio output, the cashier is free to look elsewhere. For example, with the left hand the cashier can interact with the screen 110A while looking at the scanning area and using her right hand to move an item onto the scale. The audio feedback lets the cashier know if the left hand successfully inputted the command to the POS system.

While providing audio feedback to the cashier using speaker 240A, the filter module can also provide audio feedback to the customer using directional speaker 240B which may be aligned in a direction normal to the plane established by screen 110B. Because the touch screens 110 do not provide the same physical feedback like other I/O devices, the customer may be unsure whether her instructions were received. For example, because of delays associated with the processing system, the customer may touch the screen 110B but it may take several seconds before the display is updated based on the customer's instruction. During this delay, the customer does not know if the system 400 is busy processing her request or if the touch was not detected by the touch controller in the monitor 105B. However, using the filter module, the computing system 400 may provide an audio feedback each time a relevant touch event is detected. Thus, even if there is a delay when processing the customer's instructions, the filter module can output the audio feedback. Once the customer hears the audio output from speaker 240B, she can know her touch input was accepted and the POS system is processing her request. This may stop the customer from repeatedly performing the same action (e.g., touching the screen 110B repeatedly) which could be interpreted as separate user commands and cause the operating system to perform an unintended function or malfunction.

The aligned speakers 240 may improve the ability of the system 400 to direct the audio feedback to the intended user. For example, if the monitors 105 are being used simultaneously, both speakers 240 may output audio feedback. If the speakers 240 were not aligned with the display screens 110, the users may be unable to determine who the audio output is for—i.e., which touch monitor 105 identified the relevant touch event. In one embodiment, the speakers 240 may be integrated into the touch monitors 105 so that their output faces in the direction normal to the screens 110. Thus, even if the monitors 105 are moved, the speakers 240 will maintain this directional relationship with the screen 110. Furthermore, the assignments of the speakers 240 to the touch monitors 105 contained within the filter module would not need to be changed if the monitors are moved. Although FIG. 4 illustrates aligning the speakers 240 relative to the screens 110, there are different techniques of arranging the speakers 240 that still provide directional audio output. For example, the speakers 240 may be mounted above areas where respective users of the touch monitors 105 are likely to stand such that the speakers 240 face down towards the user.

In addition to aligning the speakers 240A and 240B and using the filter module to determine which speaker should output the audio feedback, the system 400 may use different audio output schemas for the speakers 240. For example, the speaker 240A facing a cashier may output beeps when relevant touch events are identified while the speaker 240B facing a customer may output spoken prompts. In one embodiment, the different audio feedback schemas use different sounds so that every sound is unique to the particular schema. Doing so may further reduce user confusion and allow the user to quickly determine whether they are the intended recipient of the audio feedback. If two different audio feedback schemas are assigned to the touch monitors 105, even if the touch monitors 105 detect the same touch event (e.g., both user single tap on the screens 110), the speakers 240A and 240B output different sounds. Moreover, the different audio feedback schemes may provide audio feedback for different touch events but not others. For example, an audio feedback scheme may provide audio feedback when a user taps a screen but not when the user swipes the screen.

FIG. 5 illustrates a computer system 500 with a single speaker 540 that provides audio feedback for a plurality of touch monitors 105, according to one embodiment described herein. Computer system 500 differs from the embodiments described above in that the audio feedback for multiple speakers 105 is provided by a single speaker 540 rather than individual speakers that are assigned to each monitor 105. As shown here, speaker 540 provides audio feedback for touch events that occur on both touch monitor 105A and 105B. This may be most applicable when two touch monitors are in close physical proximity—e.g., the touch monitors 105 are mounted back-to-back. To enable the users of the monitors 105 to determine whether they are the intended recipient of the audio feedback, the computer system 500 may assign different audio feedback schemas to each of the monitors 105 as described above. As additional monitors 105 are added to the computer system 500, the filter module assigns a different audio feedback schema to the monitor 105.

To provide audio feedback, the filter module may perform the same process as that shown in FIG. 3. However, the filter module may perform the additional step of determining the audio feedback schema associated with the monitor that detected the touch event. In one embodiment, this step may instead be performed by a sound adapter that controls the speaker 540. For instance, the filter module may transmit an instruction to the sound adapter which describes the monitor and the type of the touch event. Based on this information, the sound adapter selects the corresponding sound within the audio feedback schema assigned to the monitor. Different touch events may correspond to different sounds within the schema. For a first schema, a swipe touch event may correspond to a short tone (e.g., a sound that lasts more than half a second) while a single tap touch event corresponds to a beep (e.g., a sounds that last less than half a second). For a second schema, the swipe touch event corresponds to a first verbal phrase and the single tap touch event corresponds to a second, different verbal phrase. In this manner, computing system 520 may assign different schemas to different touch monitors 105 so that a single speaker 540 may be used to provide audio feedback to two users.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the foregoing is directed to embodiments of the present invention, other and further embodiments of the invention may be devised without departing from the basic scope thereof, and the scope thereof is determined by the claims that follow.

What is claimed is:

1. A method for providing audio feedback for a first touch-sensitive display and a second touch-sensitive display, the method comprising:
receiving touch data from one of the first and second displays, the touch data indicating that a touch event occurred on one of a first integrated touch/display area in the first display and a second integrated touch/display area of the second display, wherein the first and second displays are housed in separate physical enclosures;
identifying a location of the touch event in a shared coordinate region that extends across both the first touch/display area and the second touch/display area;
selecting one of the first and second displays by correlating the location of the touch event to a sub-portion of the shared coordinate region corresponding to one of the first and second touch/display areas; and
transmitting a signal to a speaker assigned to the selected display, the signal causing the speaker to output audio feedback associated with the touch event.

2. The method of claim 1, wherein the non-selected display is assigned a different speaker, wherein the signal does not cause the audio feedback associated with the touch event to be outputted on the different speaker.

3. The method of claim 1, wherein selecting one of the first and second displays further comprises:
comparing the location of the touch event to a data structure defining dimensions of respective sub-portions of the shared coordinate region corresponding to the first and second touch/display areas.

4. The method of claim 1, wherein all of the shared coordinate region is found within the first and second touch/display areas.

5. The method of claim 4, wherein the shared coordinate region is a desktop of an operating system.

6. The method of claim 4, wherein a sub-portion of the shared coordinate region assigned to the first touch/display area and a sub-portion of the shared coordinate region assigned to the second touch/display area are non-overlapping.

7. The method of claim 1, further comprising outputting the audio feedback on the speaker, the audio feedback providing an indication to a user of the selected display that the touch event was detected by the selected display.

8. A system for providing audio feedback for a first touch-sensitive display and a second touch-sensitive display, the system comprising:
a computer processor; and
a memory containing a program that, when executed on the computer processor, performs an operation for processing data, the operation comprising:
receiving touch data from one of the first and second displays, the touch data indicating that a touch event occurred on one of a first integrated touch/display area in the first display and a second integrated touch/display area of the second display;
identifying a location of the touch event in a shared coordinate region that extends across both the first touch/display area and the second touch/display area;
selecting one of the first and second displays by correlating the location of the touch event to a sub-portion of the shared coordinate region corresponding to one of the first and second touch/display areas; and
transmitting a signal to a speaker assigned to the selected display, the signal causing the speaker to output audio feedback associated with the touch event.

9. The system of claim 8, wherein the non-selected display is assigned a different speaker, wherein the signal does not cause the audio feedback associated with the touch event to be outputted on the different speaker.

10. The system of claim 8, wherein the computer processor and memory are house in a physical enclosure different from separate physical enclosures housing the first and second displays.

11. The system of claim 8, wherein all of the shared coordinate region is found within the first and second touch/display areas

12. The system of claim 11, wherein the shared coordinate region is a desktop of an operating system stored in the memory.

13. The system of claim 11, wherein a sub-portion of the shared coordinate region assigned to the first touch/display area and a sub-portion of the shared coordinate region assigned to the second touch/display area are non-overlapping.

14. The system of claim 8, wherein the non-selected display is assigned a different speaker, wherein the speaker assigned to the selected display is arranged to face a user of the selected display and the different speaker assigned to the non-selected display is arranged to face a user of the non-selected display.

15. A computer program product for providing audio feedback for a first touch-sensitive display and a second touch-sensitive display, the computer program product comprising:
a computer-readable storage medium having computer-readable program code embodied therewith, the computer-readable program code is configured to:
receive touch data from one of the first and second displays, the touch data indicating that a touch event occurred on one of a first integrated touch/display area in the first display and a second integrated touch/display area of the second display, wherein the first and second displays are housed in separate physical enclosures;
identify a location of the touch event in a shared coordinate region that extends across both the first touch/display area and the second touch/display area;
select one of the first and second displays by correlating the location of the touch event to a sub-portion of the shared coordinate region corresponding to one of the first and second touch/display areas; and
transmit a signal to a speaker assigned to the selected display, the signal causing the speaker to output audio feedback associated with the touch event.

16. The computer program product of claim 15, wherein the non-selected display is assigned a different speaker, wherein the signal does not cause the audio feedback associated with the touch event to be outputted on the different speaker.

17. The computer program product of claim 15, wherein selecting one of the first and second displays further comprises computer-readable program code configured to:
compare the location of the touch event to a data structure defining dimensions of respective sub-portions of the shared coordinate region corresponding to the first and second touch/display areas.

18. The computer program product of claim 15, wherein all of the shared coordinate region is found within the first and second touch/display areas.

19. The computer program product of claim 18, wherein the shared coordinate region is a desktop of an operating system.

20. The computer program product of claim 18, wherein a sub-portion of the shared coordinate region assigned to the first touch/display area and a sub-portion of the shared coordinate region assigned to the second touch/display area are non-overlapping.
